(19) United States
(12) Patent Application Publication
(10) Pub. No.: US 2005/0288802 A1
(43) Pub. Date: Dec. 29, 2005

(54) Programmable logic controller, graphic logic controller, control program creation device, program, and storage medium

(76) Inventor: Masaaki Yamada, Osaka (JP)

Correspondence Address: HARNESS, DICKEY & PIERCE, P.L.C., P.O. BOX 8910, RESTON, VA, 20195, US

(21) Appl. No.: 11/158,360

(22) Filed: Jun. 22, 2005

(30) Foreign Application Priority Data
Jun. 28, 2004 (JP) 2004-189091

(51) Int. Cl. G05B 19/42; G05B 11/01; G05B 19/18; G05B 15/00

(52) U.S. Cl. 700/83; 700/11; 700/87

(57) ABSTRACT

The present invention includes: a control program storage section for storing a control program; a control section, executing a command in the control program, which controls a device; and an IF section for enabling connection to a network. The control program storage section is capable of storing, as a command in the control program, a computer control command for controlling a computer connected to the network. When the control program storage section stores a computer control command, the control section transmits through the IF section to the computer a command based on the computer control command.

This Nonprovisional application claims priority under 35 U.S.C. § 119(a) on Patent Application No. 2004/189091 filed in Japan on Jun. 28, 2004, the entire contents of which are hereby incorporated by reference.

### FIELD OF THE INVENTION

The present invention relates to a programmable logic controller, a graphic logic controller, a control program creation device for creating a control program used therein, a program, and a storage medium.

### BACKGROUND OF THE INVENTION

Conventionally, there has been known a programmable logic controller (hereinafter referred to as a PLC) which controls various devices. The PLC is a control device in which a control program can be written. The PLC follows the control program so as to control various devices, such as sensors, which are connected to the PLC.

Further, the PLC is provided with a programmable indicator (graphic control panel or panel computer). The programmable indicator (hereinafter referred to as an indicator) indicates a state of the PLC. The indicator can also transmit, to the PLC, instructions for changing various set values concerning control of various devices.

Moreover, in order to change the various set values, the indicator can display a setting image for enabling change of the various set values. More specifically, a user uses a personal computer (hereinafter referred to as a computer) to create setting image data in accordance with a device, and the data is downloaded to the indicator, so that the indicator can display the setting image.

Incidentally, there has recently been known a control system which causes a computer to execute a predetermined process in response to input from a device into a PLC. An arrangement of such a control system is shown in FIG. 7. As shown in FIG. 7, the control system 90 includes a device 91, a PLC 92, an indicator 93, and a computer 94. Further, the PLC 92 includes a control device 92a and a storage section 92b.

In the control system 90, as described above, the PLC 92 controls operation of the device 91. More particularly, the control device 92a executes a control program called a ladder program (a program created in a ladder-diagram programming language) stored in the storage section 92b, so that the PLC 92 controls operation of the device 91. Further, the control device 92a periodically monitors a state of the device 91. Moreover, when there is a change in a state of the device 91, information in accordance with the contents of the change is stored temporarily in the control device 92a. This means that when a state of the device 91 changes, a state of the control device 92a also changes. Note that a change in a state of the device 91 can be displayed in the indicator 93 through the PLC 92.

Meanwhile, the computer 94 is provided in advance with a program (hereinafter referred to as a change detection program) for detecting a change in a state of the control device 92a. Moreover, the computer 94 executes the change detection program so as to detect a change in a state of the control device 92a. When the computer 94 detects a change in a state of the control device 92a, the computer 94 executes a predetermined process in accordance with the contents of the change. Note that, as the predetermined process, activation of an application program, retrieval of a file managed by the application program, and the like are exemplified. Note that when the predetermined process has been executed, a display screen image in accordance with the program is displayed in a display device (not shown) of the computer 94.

That is, the control system 90 is arranged so that the computer 94 monitors a change in a state of the control device 92a so as to execute a predetermined program.

Further, the control system 90 can be arranged as follows so as to cause a computer to execute a predetermined process in response to input from a device into a PLC. An arrangement of this control system is shown in FIG. 8. Note that members having the same functions as those of the control system 90 are given the same reference numerals, and explanations thereof are omitted here.

As shown in FIG. 8, the control system 90′ includes a device 91, a PLC 92, an indicator 93 and a computer 94′. The computer 94′ includes a control device 94a.

The control device 94a acquires, from the PLC 92, information on the execution contents of a ladder program (control program). That is, in the control system 90′, information on the same contents as an instruction given to the device 91 is sent from the PLC 92 to the control device 94a of the computer 94.

Further, the computer 94′ is provided in advance with a change detection program for detecting a change in a state of the control device 94a. Moreover, the computer 94′ executes the change detection program so as to detect a change in a state of the control device 94a of the computer 94′. When the computer 94′ detects a change in a state of the control device 94a, the computer 94′ executes a predetermined process in accordance with the contents of the change.

That is, in the control system 90′, the computer 94′ not only acquires from the PLC 92 the information on the execution contents but also monitors a change in the control device 94a so as to execute a predetermined process.

Further, Patent Document 1 (Japanese Patent Publication No. 2965407; registered on Aug. 13, 1999) discloses an arrangement, relating to the control system 90, which, upon request from an indicator to a PLC, makes it possible to acquire, on the side of the indicator, information on a state of the PLC. Further, Patent Document 2 (Japanese Publication of Examined Application 19282/1994 (Tokukouhei 6-19282; published on Mar. 16, 1994) discloses an arrangement, relating to the control system 90′, which matches a memory area of a PLC to that of an indicator.

However, according to the foregoing arrangement of the control system 90, the change detection program for detecting a change in a state of the control device 92a of the PLC 92 needs to be stored in the computer 94. Further, according to the foregoing arrangement of the control system 90′, the computer 94′ needs to be provided with the control device 94a, and the change detection program for detecting a change in a state of the control device 94a needs to be stored in the computer 94. Note that neither the arrangement of Patent Document 1 nor that of Patent Document 2 is free from the same problems.

### SUMMARY OF THE INVENTION

The present invention has been completed in consideration of the foregoing problems and has as an object to provide a programmable logic controller, a graphic logic controller, a control program creation device, a program, and a storage medium all of which enables a computer to execute a predetermined process by simply creating a control program.

In order to solve the foregoing problems, a programmable logic controller according to the present invention is a programmable logic controller including: a storage section for storing a control program; a control section, executing a command in the control program, which controls a device; and a communication section for enabling connection to a network, wherein: the storage section is capable of storing, as the command in the control program, a terminal control command for controlling a terminal connected to the network, and when the storage section stores the terminal control command, the control section transmits through the communication section to the terminal a command based on the command in the control program.

According to the foregoing arrangement, the storage section is capable of storing, as the command in the control program, a terminal control command for controlling a terminal connected to the network. Further, the control section can be used to transmit through the communication section to the terminal a command based on the command in the control program.

Therefore, it is possible to control the terminal based on the command in the control program.

This brings about an effect of making it possible to control the terminal from the programmable logic controller by simply creating a control program. Further, this eliminates the need for monitoring the programmable logic controller from the side of the terminal when the terminal is controlled.

Further, in order to solve the foregoing problems, a graphic logic controller according to the present invention is a graphic logic controller including: a storage section for storing a control program; a control section, executing a command in the control program, which controls a device; a display section for showing a state of the device; and a communication section for enabling connection to a network, wherein: the storage section is capable of storing, as the command in the control program, a terminal control command for controlling a terminal connected to the network, and when the storage section stores the terminal control command, the control section transmits through the communication section to the terminal a command based on the command in the control program.

According to the foregoing arrangement, the graphic logic controller includes the members of the programmable logic controller.

Therefore, the graphic logic controller brings about an effect of obtaining the same effect as the programmable logic controller.

Further, in order to solve the foregoing problems, a control program creation device according to the present invention is a control program creation device creating a control program used in a programmable logic controller or a graphic logic controller which includes a communication section for enabling connection to a network, the control program creation device including a command creation section for creating, as a command in the control program, a terminal control command for controlling a terminal connected to the network.

According to the foregoing arrangement, the command creation section can be used to create, as a command in the control program, a terminal control command for controlling a terminal connected to the network.

Therefore, the terminal control command is stored, as a command in the control program, in the programmable logic controller or the graphic logic controller, and this brings about an effect of making it possible to control the terminal from the programmable logic controller or the graphic logic controller.

In order to solve the foregoing problems, a program according to the present invention allows a computer to function as the control section of the programmable logic controller.

Loading of the program into a computer brings about an effect of making it possible to provide the programmable logic controller.

In order to solve the foregoing problems, a program according to the present invention allows a computer to function as the control section of the graphic logic controller.

Loading of the program into a computer brings about an effect of making it possible to provide the graphic logic controller.

In order to solve the foregoing problems, a program according to the present invention allows a computer to function as the command creation section of the control program creation device.

Loading of the program into a computer brings about an effect of making it possible to provide the control program creation device.

In order to solve the foregoing problems, a storage medium according to the present invention stores any one of the programs.

Loading into a computer the program stored in the storage medium brings about an effect of making it possible to provide the programmable logic controller, the graphic logic controller, or the control program creation device.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a diagram showing a schematic arrangement of a control system according to an embodiment of the present invention.

FIG. 2 is a ladder diagram concerning a ladder program stored in a PLC.

FIG. 3 is a diagram showing a specific arrangement of a command indicated by a ladder symbol Iε.

FIG. 4 is a diagram showing, by another description method, the command indicated by the ladder symbol Iε.

FIG. 5 is a functional block diagram of a control program creation device.

FIG. 6 is a diagram showing a schematic arrangement of a graphic logic controller.

FIG. 7 is a diagram showing an example arrangement of a conventional control system.

FIG. 8 is a diagram showing an example arrangement of another conventional control system.

### DESCRIPTION OF THE EMBODIMENTS

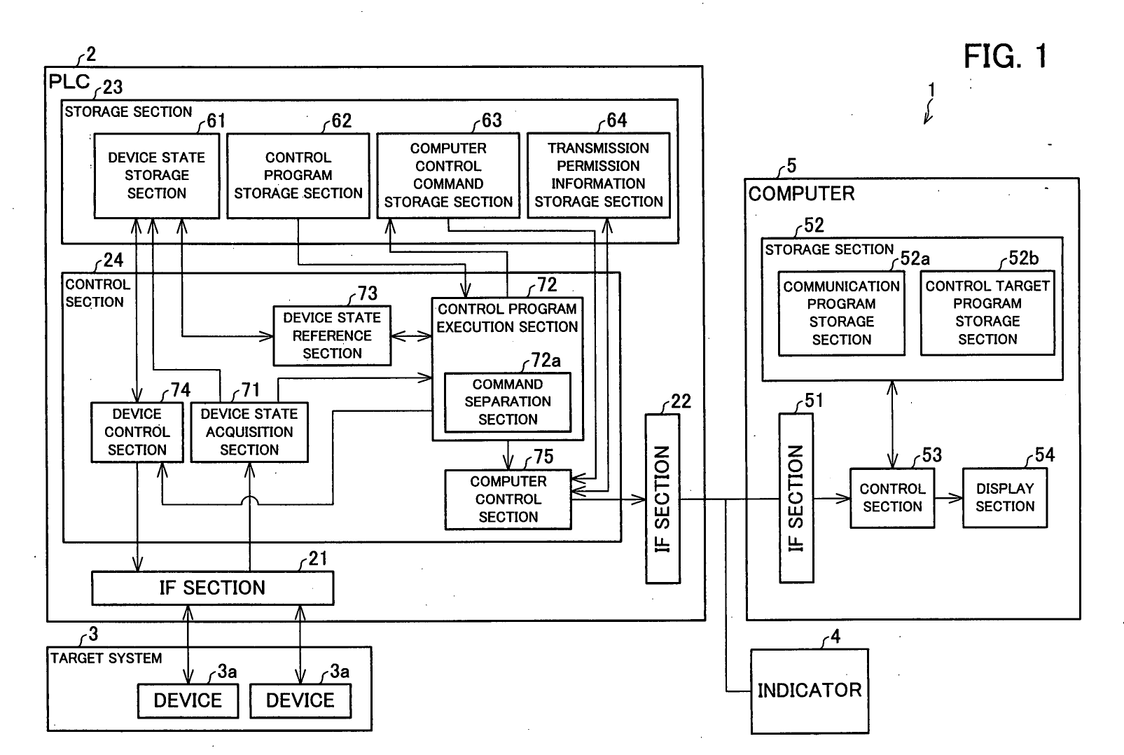

One embodiment of the present invention will be described below with reference to FIGS. 1 to 6.

FIG. 1 shows a schematic arrangement of a control system 1 according to one embodiment of the present invention. As shown in FIG. 1, the control system 1 includes a PLC (programmable logic controller) 2, a target system 3, an indicator (programmable indicator) 4, and a computer (terminal) 5.

The PLC 2 includes an IF section 21, an IF section (communication section) 22, a storage section 23, and a control section 24. Further, the storage section 23 includes a device state storage section 61, a control program storage section 62, a computer control command storage section 63, and a transmission permission information storage section 64. Furthermore, the control section 24 includes a device state acquisition section 71, a control program execution section 72, a device state reference section 73, a device control section 74, and a computer control section 75. Furthermore, the control program execution section 72 includes a command separation section 72a. Note that the control program storage section 62 corresponds to the storage section as set forth in claims.

Note that the members (24, 72, 72a, 73, 74, and 75) are functional blocks which are achieved when a CPU executes a program stored in a storage device such as the storage section 23 so as to control a peripheral circuitry (not shown) such as an I/O (input/output) circuitry. Operation of the functional blocks will be described later.

The target system 3 is a target to be controlled by the PLC 2 and includes at least one device 3a. Moreover, the device 3a is communicably connected to the IF section 21 of the PLC 2.

The indicator 4 indicates a state of the PLC 2. The indicator 4 can also transmit, to the PLC 2, instructions for changing various set values concerning control of the device 3a. Moreover, in order to change the various set values, the indicator 4 can display a setting image for changing the various set values. Further, the indicator 4 is communicably connected to the control section 24 of the PLC 2 through the IF section 22 of the PLC 2.

The computer 5 includes an IF section 51, a storage section 52, a control section 53, and an indicator 54. Further, the computer 5 is communicably connected through the IF section 51 to the IF section 22 of the PLC 2 over a network. Further, the storage section 52 includes a communication program storage section 52a and a control target program storage section 52b. Furthermore, the storage section 52 stores an operating system (OS). As the operating system, for example, a Windows (trademark) system can be used.

Note that the members (53 and 54) are functional blocks which are achieved when a CPU executes a program stored in a storage device such as the storage section 52 so as to control a peripheral circuitry (not shown) such as an I/O circuitry. Operation of the functional blocks will be described later. Note that, as the computer 5, for example, a personal computer and the like are exemplified.

In the following, each of the functional blocks of the PLC 2 will be described.

The IF section 21 is an interface designed to perform communication with the device 3a of the target system 3. Further, the IF section 21 is connected to the device state acquisition section 71 and the device control section 74 of the control section 24.

The IF section 22 is an interface designed to perform communication with the indicator 4 and the computer 5. Further, the IF section 22 is connected to the control section 24. Note in FIG. 1 that, for the sake of convenience in description, the IF section 22 is connected to the computer control section 75 of the control section 24.

The device state storage section 61 is a storage area which stores information concerning a state of the device 3a. Further, as the information concerning a state of the device 3a, for example, information which indicates a state of a device and information which indicates a state of a device serving as a control target (i.e., a state of a control target) are exemplified.

The control program storage section 62 is a storage area which prestores a program (hereinafter referred to as a control program) for controlling the device 3a and the computer 5. Further, the control program includes a command (hereinafter referred to as a device control command) for changing a state of the device 3a and a command (hereinafter referred to as a computer control command) for controlling the computer 5.

The computer control command includes at least an operation code (operator) indicating the command and an operand corresponding to a command (hereinafter referred to as a computer transmission command) which is actually transmitted to the computer 5. Further, the computer control command may include another operand. Note that the computer transmission command corresponds to a command based on the terminal control command as set forth in claims.

The computer control command storage section 63 is a storage area for temporarily storing the computer control command.

The transmission permission information storage section 64 is a storage area which stores information on whether or not the computer control section 75 is permitted to transmit the computer transmission command to the computer 5. In a default state, the transmission permission information storage section 64 stores information which permits transmission of the computer transmission command.

The device state acquisition section 71 periodically acquires, through the IF section 21, information on a state of the device 3a (the information is hereinafter referred to as state information). Furthermore, the device state acquisition section 71 stores the acquired state information in the device state storage section 61. In this way, the state information is stored in the device state storage section 61. Further, when the device state acquisition section 71 causes the device state storage section 61 to store the state information, the device state acquisition section 71 sends, to the control program execution section 72, notification (e.g., a signal telling) that the state information has been stored in the device state storage section 61.

When the control program execution section 72 receives the signal from the device state acquisition section 71, the control program execution section 72 reads out a control program from the control program storage section 62. Moreover, the control program execution section 72 executes the control program read out.

Incidentally, when the control program is executed, state information on the predetermined device 3a may be needed in the process of execution. In this case, the control program execution section 72 sends a predetermined signal to the device state reference section 73. When the device state reference section 73 receives the predetermined signal from the control program execution section 72, the device state reference section 73 accesses the device state storage section 61 so as to acquire state information on the predetermined device 3a. Moreover, the device state reference section 73 sends the state information to the control program execution section 72. This enables the control program execution section 72 to acquire state information on the predetermined device 3a.

Further, the control program contains the device control command and the computer control command. Accordingly, the command separation section 72a separates, sequentially into a device control command and a computer control command, a command obtained in the process of execution.

When a device control command is obtained as a result of separation by the command separation section 72a, the control program execution section 72 sends the device control command to the device control section 74. When the device control section 74 receives the device control command from the control program execution section 72, the device control section 74 rewrites device state information stored in the device state information storage section 61 so that the device state information matches the contents indicated by the device control command.

Meanwhile, when a computer control command is obtained as a result of separation by the command separation section 72a, the control program execution section 72 causes the computer control command storage section 60 to temporarily store the obtained computer control command.

Further, when execution of a predetermined number of times of control programs is completed, the control program execution section 72 sends a predetermined signal to the device control section 74 and the computer control section 75.

When the device control section 74 receives the predetermined signal from the control program execution section 72, the device control section 74 reads out device state information from the device state storage section 61. Moreover, the device control section 74 transmits a command to the device 3a through the IF section 21 so that the device 3a matches a state indicated by the state information read out. This changes a state of the device 3a.

Further, when the computer control section 75 receives the predetermined signal from the control program execution section 72, the computer control section 75 acquires a computer control command from the computer control command storage section 63. Furthermore, the computer control section 75 interprets (translates) the computer control command so as to acquire the computer transmission command. Further, the computer control section 75 accesses the transmission permission information storage section 64 so as to determine whether or not the transmission permission information storage section 64 stores information which permits transmission of the computer transmission command. When the computer control section 75 determines that the transmission permission information storage section 64 stores information which permits transmission of the computer transmission command, the computer control section 75 transmits the computer transmission command through the IF section 22 to the computer 5. Furthermore, when transmission of the computer transmission command is completed, the computer control section 75 converts information, stored in the transmission permission information storage section 64, which permits transmission of the computer transmission command, once into information which prohibits transmission of the computer transmission command. Note that an arrangement in which the prohibition information is converted again into the permission information will be described later.

In the following, operation of each of the functional blocks of the computer 5 will be described.

The IF section 51 is an interface designed to perform communication with the PLC 2 and the indicator 4. Further, the IF section 51 is connected to the control section 53.

The communication program storage section 52a is a storage area which prestores a program for performing communication with the PLC 2. Further, the control target program storage section 52b is a storage area which prestores software programs (control target programs and application programs) such as a document creation software program, a spreadsheet software program, and a WWW browser (World Wide Web browser). Note that the WWW browser is a software program which retrieves a WWW server and displays an HTML file. That is, the WWW browser is a software program for browsing a WWW page on the Internet. Note that a software program stored in the control target program storage section 52b is not limited to those described above. Further, in the following description, it is assumed that the computer 5 is connected to the Internet.

Further, an operating system to be stored in the storage section 52b only needs to be an operating system which can receive a computer transmission command transmitted from the PLC2 so as to execute the computer transmission command.

The control section 53 first reads out a communication program from the communication program storage section 52a and executes the communication program so as to communicably connect the computer 5 to the PLC 2. Note that reading out and execution of the communication program are processed through input from a control section (not shown) of the computer 5. Note that further specific operation of the control section 53 will be described later in a First Example and a Second Example.

Moreover, when the control section 53 receives a computer transmission command from the PLC 2 through the IF section 51, the control section 53 reads out a control target program so as to execute a process in accordance with the acquired computer transmission command. When the executed process can be displayed on a screen, the control section 53 causes the display section 54 to show a result of the execution.

As described above, the PLC 2 according to the present embodiment includes: the control program storage section (storage section) 62 for controlling a control program; the control section 24, executing a command in the control program, which controls the device 3a; and the IF section (communication section) 22 for enabling connection with a network, wherein: the control program storage section 62 is capable of storing, as the command in the control program, a computer control command (terminal control command) for controlling the computer (terminal) 5 connected to the network, and when the control program storage section stores the computer control command, the control section 24 transmits through the IF section 22 to the computer 5 a computer transmission command (command based on the computer control command).

According to the foregoing arrangement, the control program storage section 62 is capable of storing, as the command in the control program, a computer control command for controlling the computer 5 connected to the network. Further, it is possible to use the control section 24 to transmit a computer transmission command through the IF section 22 to the computer 5.

Therefore, it is possible to control the computer 5 based on the command in the control program. This brings about an effect of making it possible to control the computer 5 from the PLC 2 by simply creating a control program. Further, this eliminates the need for monitoring the PLC 2 from the side of the computer 5 when the computer 5 is controlled.

Further, the PLC 2 includes the command separation 72a for separating a computer control command from the command in the control program.

According to the foregoing arrangement, the command separation 72a can be used to separate a computer control command from the command in the control program.

Therefore, this brings about an effect of making it possible to transmit to the computer 5 only a computer transmission command (command based on the computer control command).

Further, the control system 1 is arranged so that the single computer 5 is connected to the PLC 2, but the control system 1 is not so limited. The control system 1 may be arranged so that a plurality of computers, each of which is the computer 5, are connected to the PLC 2.

In case of this arrangement, it is only necessary to allow the control program to contain, in addition to the computer control command, identification information for identifying the computer 5 serving as a control target. Further, in this case, an arrangement only needs to be such that the computer control section 75 transmits a computer transmission command to the computer 5 indicated by the identification information. This makes it possible to transmit a predetermined computer transmission command to the predetermined computer 5.

In the following, a specific example of the computer control command and an example arrangement of a control program containing the computer control command will be described with reference to the First and Second Examples.

### FIRST EXAMPLE

In the present Example, a case will be described in which a control target program stored in a control target program storage section 52a is activated upon an instruction from a PLC 2. That is, a case will be described in which an operating system of a computer 5 is instructed to activate the control target program.

Further, for the sake of convenience in description, a ladder program will be described as an example of a control program stored in a control program storage section 62 of the PLC 2. Furthermore, in the following description, a case will be described for example in which a plurality of computers, each of which is the computer 5, are connected to the PLC 2.

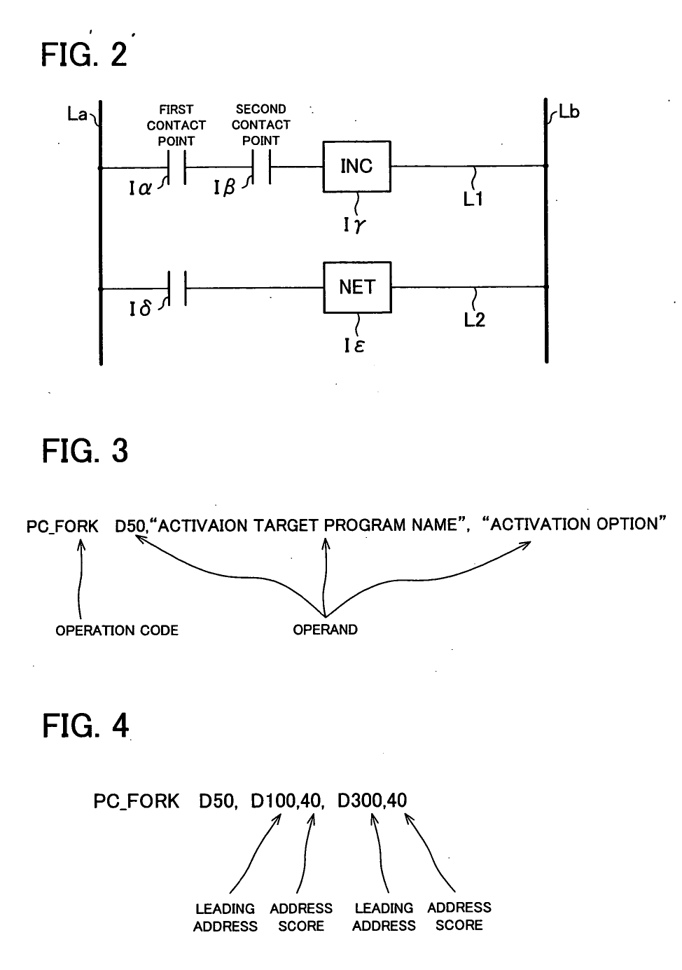

FIG. 2 shows one example of a ladder diagram concerning a ladder program according to the present Example. As shown in FIG. 2, the ladder diagram includes a left generating line (La) and a right generating line (Lb). The left and right generating lines are connected by one or more networks (L1 and L2). The networks L1 and L2 include ladder symbols (Iα, Iβ, Iγ, Iδ, and Iε) and their related labels. The ladder symbols serve as functional blocks, such as a contact point, a coil, and a counter, which are represented by figures and other forms. In this way, the ladder diagram illustrates a control procedure according to types of the ladder symbols disposed therein and a way in which the generating lines, the networks, and the ladder symbols are connected to one another.

Moreover, in FIG. 2, the ladder symbol Iα, which indicates a load connected to the generating line La, is connected to the generating line Lb through the ladder symbol Iβ, which indicates an AND, the ladder symbol Iγ, which indicates an increment. Further, the ladder symbol Iδ, which indicates a trigger connected to the generating line La, is connected to the generating line Lb through the ladder symbol Iε, which indicates activation of a control target program. When a first contact point corresponding to the ladder symbol Iα and a second contact point corresponding to the ladder symbol Iβ are both turned on, a numeric value of the counter is incremented. Further, a contact point corresponding to the ladder symbol Iδ is turned on when a predetermined event occurs, so that the predetermined computer 5 is notified of an activation command concerning the predetermined control program.

Moreover, when the predetermined computer 5 receives the activation command, the computer 5 follows the activation command so as to activate the predetermined program. This allows a command contained in a ladder program to activate a program of the computer 5.

In the following, a specific arrangement of a command indicated by the ladder symbol Iε will be described with reference to FIG. 3. As shown in FIG. 3, the command (i.e., a computer control command) indicated by the ladder symbol Iε contains one operation code and three operands. The operation code is “PC_FORK”, and the operands are “D50”, “Activation Target Program Name”, and “Activation Option”.

“D50” is an operand indicative of a leading address, concerning information on the computer 5 serving as a control target, which is located in a storage section 23. Further, “Activation Target Program Name” is an operand which indicates the name of a program serving as an activation target. For example, when a spreadsheet software program is an activation target, the name of the software program is shown as a character string in a column of “Activation Target Program Name”. Note that the same applies also when a WWW browser is an activation target. “Activation Option” is an operand which indicates, as a character string, the name of a file in case of a spreadsheet software program or the name of a URL (uniform resource locator) in case of a WWW browser. Note that “Activation Option” is an option setting item, and when there is no need to open a predetermined file (i.e., when only a program is activated), a column of “Activation Option” may be left blank.

“PC_FORK” is an operation code, predefined in the PLC 2, which activates that predetermined program in a predetermined computer which is identified by the three operands. Specifically, “PC_FORK” is an operation code which, based on the three operands, sets a predetermined program activation command (i.e., a computer transmission command) for a predetermined computer and notifies the computer of the command.

Therefore, by transmitting to the predetermined computer 5 a program activation command (computer transmission command) interpreted (translated) by the PLC 2 from a command indicated by the ladder symbol Iε, it is possible at least to activate a predetermined program in the computer 5.

Further, in the foregoing, the name of a software program is described directly in an operand called “Activation Target Program Name”. However, the present invention is not necessarily so limited. Further, although the name of a file is described directly in an operand called “Activation Option”, this is not for the purpose of limitation. For example, as shown in FIG. 4, the operands of “Activation Target Program Name” and “Activation Option” may be described indirectly. Note that FIG. 4 is a diagram showing, by another description method, the command indicated by the ladder symbol Iε.

FIG. 4 describes a leading address (D100) and an address score (40) (i.e., information which indicates how many addresses there are). The leading address D100, serving as “Activation Target Program Name”, is located in the storage section 23 which stores the name of a program to be activated. That is, FIG. 4 shows, instead of the name of a program serving as an activation target, a storage area (from address 100 to address 139) which stores the name of the program serving as an activation target. Further, FIG. 4 describes a leading address (D300) and an address score (40). The first address D300, serving as “Activation Option”, is located in the storage section 23 which stores the name of a predetermined file or the name of a URL.

Also with such description, the same effect can be obtained as in the case where the name of the software program and the like are described directly in the operands of “Activation Target Program Name” and “Activation Option”. Note that, the operands only need to have information (flags) to determine whether the command indicated by the ladder symbol Iε is described directly or indirectly as described above.

Note in the foregoing that the operands of “Activation Target Program Name” and “Activation Option” correspond to “message data which instructs execution of the predetermined program” as set forth in claims.

As described above, the PLC 2 is arranged so that: the computer control command contains an operand which indicates a program to be activated in the computer 5, and when the control section 24 receives an instruction to execute the computer control command, the control section 24 instructs the computer 5 to activate the program indicated by the operand of the command.

Further, the following arrangement is also possible. First, a user registers in the computer 5 a predetermined name of a combination of a command for activating a program and a command for specifying an option at the time of activating the program. Meanwhile, the PLC 2 is arranged so that the predetermined name is transmitted as a computer transmission command to the computer 5. Further, in such an arrangement, the computer 5 is arranged so that when the computer 5 receives the predetermined name from the PLC 2, the computer 5 determines by the name a command for activating a program and a command for specifying an option at the time of activating the program and activates the program in accordance with the commands. Also with this arrangement, it is possible to activate from the PLC 2 a predetermined program of the computer 5. Further, by shortening the data length of the predetermined name, the predetermined name can be transmitted to a terminal in a shorter period of time.

### SECOND EXAMPLE

In the present embodiment, a case will be described in which a control target program stored in a control target program storage section 52b is operated upon an instruction from a PLC 2 (under such conditions that the control target program is activated). That is, a case will be described in which a control target program in a computer 5 is instructed to operate. Further, a ladder program is described as an example of a control program stored in a control program storage section 62.

First, a control section 53 of the computer 5 gives a name to information on a destination of a computer transmission command. The information (hereinafter referred to as the information on the destination) contains a window handle concerning the control target program, a function address of a callback destination, and the like. Then, the information on the destination is stored in the control section 52. Note that the window handle is a number used to refer to a window in which the control target program is open.

Further, an API (application program interface) provided in an operating system can be used to store the destination information. Note that the API is a configuration for using various functions of an operating system from an application program. In other words, it is a configuration for calling up various functions prepared by the operating system.

As described above, the computer 5 stores the information on the destination of the computer transmission command, so that the name can be coordinated with the information on the destination of the computer transmission command. Therefore, the computer 5 can identify, according to the name, the information on the destination of the computer transmission command.

Accordingly, when the PLC 2 is arranged so as to transmit to the computer 5 the name and the computer transmission command, it becomes possible to instruct the control target program to operate. That is, the name is used also in the PLC 2. In this case, it is only necessary to describe a computer control program in a command indicated by a ladder symbol (e.g., Iε) so that when the command is interpreted in the PLC 2, the name and the computer transmission command can be set and sent to the computer 5.

The foregoing arrangement of the control system 1 allows, in the computer 5, file operation of a control target program (opening and closing of a file, enlarging and reducing of a window size, and the like) and image display based on a new URL (i.e., display image switching).

As described above, the PLC 2 is arranged so that: the computer control command contains an operand which indicates a file to be read out in the computer 5, and when the control section 24 receives an instruction to execute the computer control command, the control section 24 instructs the computer 5 to read out the file indicated by the operand of the command. Further, the PLC 2 is also arranged so that: the computer control command includes an operand which indicates a display image to be changed in the computer 5, and when the control section 24 receives an instruction to execute the computer control command, the control section 24 instructs the computer 5 to change the display image indicated by the operand of the command.

Incidentally, in the foregoing, communications from the PLC 2 to the computer 5 in the control system 1 are described including the First and Second Examples. In the following, communications from the computer 5 to the PLC 2 in the control system 1 will be described.

After the PLC 2 transmits the computer transmission command to the computer 5 and the computer 5 executes a process based on the computer transmission command received from the PLC 2, the control section 53 of the computer 5 transmits, through the IF section 51 to the PLC 2, notification that the process based on the command is completed (hereinafter, the notification is referred to as process completion notification). When the PLC 2 receives the process completion notification, a computer control section 75 of the PLC 2 rewrites information, stored in a transmission permission information storage section 64, which prohibits transmission of the computer transmission command, into information which permits transmission of the computer transmission command. This enables the PLC 2 to transmit the computer transmission command to the computer 5.

Further, with the foregoing arrangement, the PLC 2 cannot transmit the computer transmission command to the computer 5 until the PLC 2 receives the process completion notification from the computer 5. This eliminates such a problem that a new computer transmission command is sent to the computer 5 before the process of execution of the command is completed. That is, it is possible in the computer 5 to prevent plural processes based on the computer transmission command from being executed. Especially, because there is a time difference between a period during which the PLC 2 acquires device information and time required in executing a process based on the computer transmission command, the foregoing arrangement is effective.

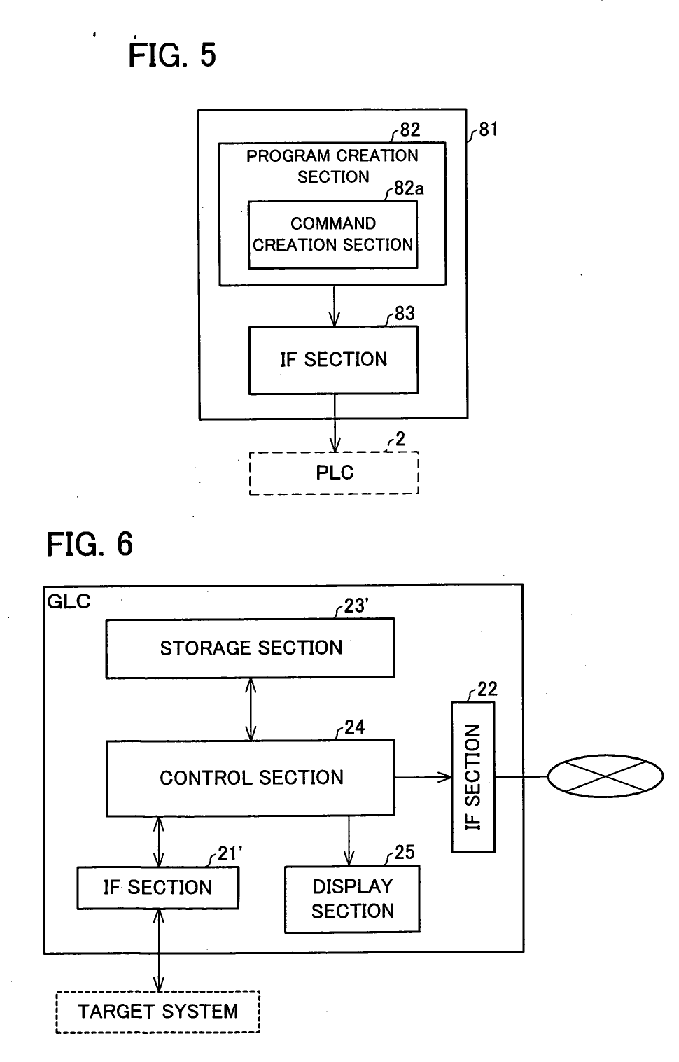

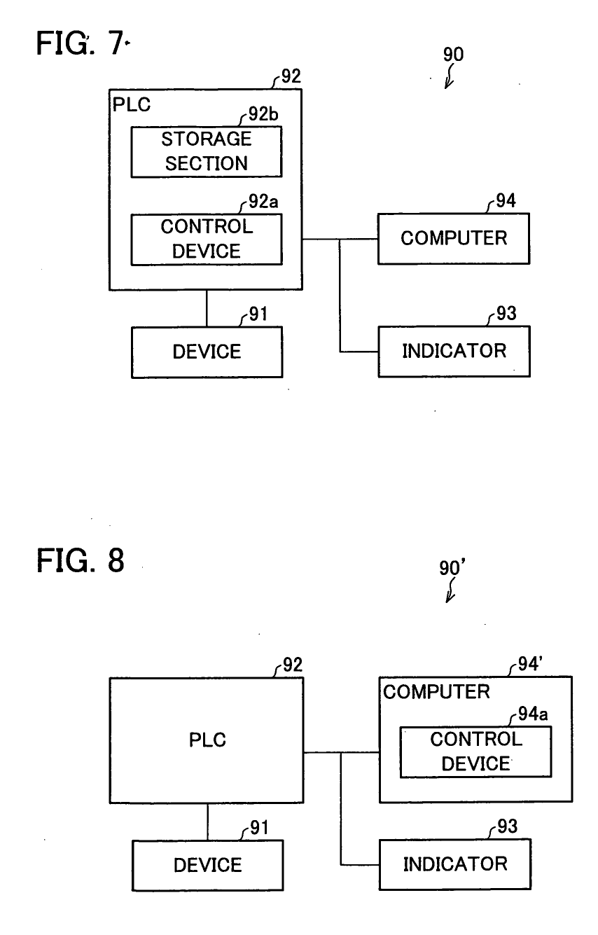

Incidentally, the control system 1 may be arranged so as to include a control program creation device for creating the control program. As shown in FIG. 5, the control program creation device 81 includes a program creation section 82 and an IF section (communication section) 83. Furthermore, the program creation section 82 includes a command creation section 82a.

The program creation section 82 receives a predetermined operation from a user so as to create a control program used in the PLC 2. Further, the command creation section 82a creates, as a command in the control program, the computer control command for controlling the computer 5.

The IF section 83 is an interface for enabling communication with the PLC 2 and transmits to the PLC 2 a control program which contains the computer control command.

Note that the control program creation device 81 may be arranged so as to be connected directly to the PLC 2 through the IF section 83 or may be arranged so as to be connected indirectly to the PLC 2 through the IF section 83 and the indicator 4. At least, an arrangement only needs to be such that the control program created in the control program creation section 81 can be transmitted to the PLC 2 and the transmitted control program can be executed in the PLC 2.

Thus, the control program creation device 81 is a control program creation device creating a control program used in the PLC 2 which includes the IF section (communication section) 83 for enabling connection to a network, the control program creation device including the command creation section 82a for creating, as a command in the control program, a computer control command (terminal control command) for controlling the computer (terminal) 5 connected to the network.

According to the foregoing arrangement, the command creation section 82a can be used to create, as a command in the control program, a computer control command for controlling the computer 5 connected to the network.

Therefore, by allowing the PLC 2 to store the computer control command as a command in the control program, it becomes possible to control the computer 5 from the PLC 2.

Further, the control program creation device 81 is arranged so that the PLC 2 instructs activation of a program of the computer 5. In this arrangement, the command creation section 82a of the program creation section 82 can receive input for identifying the program to be activated in the computer 5, and upon receipt of the input, the command creation section 82a creates a computer control command that contains an operand indicating activation of the program.

Furthermore, the control program creation device 81 is arranged so that the PLC 2 instructs reading out of a file of the computer 5. In this arrangement, the command creation section 82a of the program creation section 82 can receive input for identifying the file to be read out in the computer 5, and upon receipt of the input, the command creation section 82a creates a computer control command that contains an operand indicating reading out of the file.

Further, the control program creation device 81 is arranged so that the PLC 2 instructs change of a display image of the computer 5. In this arrangement, the command creation section 82a of the program creation section 82 can receive input for identifying the display image to be changed in the computer 5, and upon receipt of the input, the command creation section 82a creates a computer control command that contains an operand indicating change of the display image.

Incidentally, there is also known an indicator arranged so as to have a function of a PLC. Such an indicator having a function of a PLC is called a GLC (graphic logic controller). As shown in FIG. 6, the GLC includes: a storage section 23′ for storing a control program; a control section 24′, executing a command in the control program, which control a device; a display section 25 for showing a state of the device: an IF section (communication section) 22′ for enabling connection to a network; and an IF section 21′ for enabling communication with a target system device. Therefore, the GLC may be used instead of the PLC 2 and the indicator 4 of the control system 1.

Further, in the foregoing, a “Windows (trademark) system is exemplified as an operating system of the computer 5. However, this is not the purpose of limitation. That is, an operating system only needs to receive from outside a command of a predetermined format so as to execute a process based on the command.

Further, in each of the foregoing Examples, a case in which a control program is activated upon an instruction from the PLC 2 is described separately from a case in which the control program is operated upon an instruction from the PLC 2. However, this is not for the purpose of limitation. For example, an arrangement may be such that the control program is both activated (activation of an application program) and operated (reading out of a file managed by the application program, and change of a display image in the computer 5). Furthermore, an arrangement may be such that a plurality of operations of the control program (reading out of the file and change of the display screen image) are executed.

As described above, a programmable logic controller according to the present invention is a programmable logic controller including: a storage section for storing a control program; a control section, executing a command in the control program, which controls a device; and a communication section for enabling connection to a network, wherein: the storage section is capable of storing, as the command in the control program, a terminal control command for controlling a terminal connected to the network, and when the storage section stores the terminal control command, the control section transmits through the communication section to the terminal a command based on the command in the control program.

Further, it is preferable that the programmable logic controller further include a command separation section for separating the terminal control command from the command in the control program.

According to the foregoing arrangement, the command separation section can be used to separate the terminal control command from the command in the control program.

This brings about an effect of making it possible to transmit to the terminal only the command based on the terminal control command.

Further, it is preferable that the programmable logic controller be arranged so that the command based on the terminal control command is a command for executing a predetermined program stored in the terminal.

According to the foregoing arrangement, the command based on the terminal control command is a command for executing a predetermined program stored in the terminal.

This brings about an effect of making it possible to execute the predetermined program in the terminal.

Further, it is preferable that the programmable logic controller according to the present invention be arranged so that: the terminal stores a predetermined name corresponding to message data which instructs execution of the predetermined program; and the control section transmits the predetermined name as the command based on the terminal control command.

According to the foregoing arrangement, the terminal stores a predetermined name corresponding to message data which instructs execution of the predetermined program. Further, the control section transmits the predetermined name as the command based on the terminal control command.

Therefore, by transmitting the predetermined name, the terminal can be controlled. Furthermore, by causing the data length of the predetermined name to be shorter than that of the message data, the predetermined name can be transmitted to the terminal in a shorter period of time.

Further, it is preferable that the programmable logic controller according to the present invention be arranged so that the execution of the predetermined program includes at least one of activation of an application program, retrieval of a file managed by the application program, and change of a display screen image in the terminal.

According to the foregoing arrangement, the execution of the predetermined program includes at least one of (i) activation of an application program, (ii) reading out of a file managed by the application program, and (iii) change of a display image in the terminal.

Therefore, when the execution of the predetermined program includes activation of an application program, the programmable logic controller can be used to activate the application program in the terminal. Further, when the execution of the predetermined program includes reading out of a file managed by the application program, the programmable logic controller can be used to read out the file managed by the application program in the terminal. Furthermore, when the execution of the predetermined program includes change of a display image in the terminal, the programmable logic controller can be used to change the display image in the terminal.

Further, it is preferable that the programmable logic controller according to the present invention be arranged so that the control program contains identification information for identifying the terminal in accordance with the terminal control command.

According to the foregoing arrangement, the control program contains identification information for identifying the terminal in accordance with the terminal control command. That is, each terminal control command is provided with identification information for identifying a terminal.

Therefore, the programmable logic controller, based on the identification information, identifies a destination of a command based on the terminal control command. This brings about an effect of making it possible to transmit to a predetermined terminal a command based on a predetermined terminal control command.

Further, it is preferable that the programmable logic controller be arranged so that the terminal control command includes an operation code and an operand, and the control section transmits, as a command based on the terminal control command, a command corresponding to the operand.

Further, as described above, a graphic logic controller according to the present invention is a graphic logic controller including: a storage section for storing a control program; a control section, executing a command in the control program, which controls a device; a display section for showing a state of the device; and a communication section for enabling connection to a network, wherein: the storage section is capable of storing, as the command in the control program, a terminal control command for controlling a terminal connected to the network, and when the storage section stores the terminal control command, the control section transmits through the communication section to the terminal a command based on the command in the control program.

Further, a control program creation device is a control program creation device creating a control program used in a programmable logic controller or a graphic logic controller which includes a communication section for enabling connection to a network, the control program creation device including a command creation section for creating, as a command in the control program, a terminal control command for controlling a terminal connected to the network.

According to the foregoing arrangement, the command creation section can be used to create, as a command in the control program, a terminal control command for controlling a terminal connected to the network.

Therefore, by allowing the programmable logic controller or the graphic logic controller to store the terminal control command as a command in the control program, the programmable logic controller or the graphic logic controller can be used to control the terminal.

As described above, a program according to the present invention allows a computer to function as the control section of the programmable logic controller.

As described above, a program according to the present invention allows a computer to function as the control section of the graphic logic controller.

As described above, a program according to the present invention allows a computer to function as the command creation section of the control program creation device.

As described above, a storage medium according to the present invention stores any one of the programs.

Further, according to the present invention, a programmable logic controller or a graphic logic controller can be used to control a terminal connected to a network. Therefore, the present invention can be applied to a control system including these controllers and the terminal.

The present invention is not to be limited to the foregoing embodiments and varied in many ways within the scope of the claims. That is, also embodiments obtained by combining the technical means respectively disclosed in different embodiments are included in the technical scope of the present invention.

Operating means such as a CPU executes a program stored in storage means such as a ROM (read only memory) and a RAM (random access memory) so as to control input means (e.g., a keyboard), output means (e.g., a display), or communication means (e.g., an interface circuit). In this way, the members and processes of the foregoing embodiment PLC 2 are achieved and executed. Therefore, various functions and processes of the present embodiment PLC2 can be achieved by simply causing a computer having these means to read and execute the program stored in a storage medium. Further, by storing the program in a removable storage medium, the various functions and processes can be achieved on any computer.

The storage medium may be a memory (not shown; e.g., a ROM) for performing a process on a microcomputer. Alternatively, the storage medium may be a storage medium which can be read by being inserted into a program reading device (not shown) serving as an external storage device.

Further, in either case, it is preferable that the stored program be arranged so as to be accessed and executed by a microprocessor. Furthermore, it is preferable that the program is read out and then downloaded into a program storage area of a microcomputer so as to be executed. Note that the download program is prestored in the PLC 2 (or GLC).

Further, the storage medium is arranged so as to be separated from the PLC 2. Exemplified as the storage medium are a tape-type storage medium (e.g., a magnetic tape or a cassette tape), a disk-type storage medium (e.g., a magnetic disk such a flexible disk or a hard disk or CD/MO/MD/DVD disk), a card-type storage medium (e.g., an IC card such as a memory card), or a semiconductor memory (e.g., a mask ROM, an EPROM (erasable programmable read only memory), an EEPROM (electrically erasable programmable read only memory), and a flash ROM).

Further, when the system is arranged so as to be connected to a communication network including the Internet, it is preferable that the program medium be a storage medium which stores a program for downloading a program from a communication network.

Furthermore, when a program is downloaded from a communication network, it is preferable that a download program be prestored in the PLC 2 (or GLC) or installed from another storage medium.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A programmable logic controller, comprising:
a storage section for storing a control program;
a control section, executing a command in the control program, which controls a device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

2. The programmable logic controller according to claim 1, further comprising a command separation section for separating the terminal control command from the command in the control program.

3. The programmable logic controller according to claim 1, wherein the command based on the terminal control command is a command for executing a predetermined program stored in the terminal.

4. The programmable logic controller according to claim 2, wherein the command based on the terminal control command is a command for executing a predetermined program stored in the terminal.

5. The programmable logic controller according to claim 3, wherein:
the terminal stores a predetermined name corresponding to message data which instructs execution of the predetermined program, and
the control section transmits the predetermined name as the command based on the terminal control command.

6. The programmable logic controller according to claim 4, wherein:
the terminal stores a predetermined name corresponding to message data which instructs execution of the predetermined program, and
the control section transmits the predetermined name as the command based on the terminal control command.

7. The programmable logic controller according to claim 3, wherein the execution of the predetermined program includes at least one of (i) activation of an application program, (ii) reading out of a file managed by the application program, and (iii) change of a display screen image in the terminal.

8. The programmable logic controller according to claim 4, wherein the execution of the predetermined program includes at least one of (i) activation of an application program, (ii) reading out of a file managed by the application program, and (iii) change of a display screen image in the terminal.

9. The programmable logic controller according to claim 5, wherein the execution of the predetermined program includes at least one of (i) activation of an application program, (ii) reading out of a file managed by the application program, and (iii) change of a display screen image in the terminal.

10. The programmable logic controller according to claim 6, wherein the execution of the predetermined program includes at least one of (i) activation of an application program, (ii) reading out of a file managed by the application program, and (iii) change of a display screen image in the terminal.

11. The programmable logic controller according to claim 2, wherein the control program contains identification information for identifying the terminal in accordance with the terminal control command.

12. A graphic logic controller, comprising:
a storage section for storing a control program;
a control section, executing a command in the control program, which controls a device;
a display section for showing a state of the device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

13. A control program creation device creating a control program used in a programmable logic controller or a graphic logic controller which includes a communication section for enabling connection to a network,
the control program creation device comprising a command creation section for creating, as a command in the control program, a terminal control command for controlling a terminal connected to the network.

14. A program, causing a computer to function as a control section of a programmable logic controller which includes:
a storage section for storing a control program;
the control section, executing a command in the control program, which controls a device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

15. A program, causing a computer to function as a control section of a graphic logic controller which includes:
a storage section for storing a control program;
the control section, executing a command in the control program, which controls a device;
a display section for showing a state of the device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

16. A program, causing a computer to function as a command creation section of a control program creation device creating a control program used in a programmable logic controller or a graphic logic controller which includes a communication section for enabling connection to a network, wherein
the control program creation device includes a command creation section for creating, as a command in the control program, a terminal control command for controlling a terminal connected to the network.

17. A storage medium, storing a program causing a computer to function as a control section of a programmable logic controller which includes:
a storage section for storing a control program;
the control section, executing a command in the control program, which controls a device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

18. A storage medium, storing a program causing a computer to function as a control section of a graphic logic controller which includes:
a storage section for storing a control program;
the control section, executing a command in the control program, which controls a device;
a display section for showing a state of the device; and
a communication section for enabling connection to a network, wherein:
the storage section is capable of storing, as the command in the control program, a terminal control command for controlling a terminal connected to the network, and
when the storage section stores the terminal control command, the control section transmits through the communication section to the terminal a command based on the terminal control command.

19. A storage medium, storing a program causing a computer to function as a command creation section of a control program creation device creating a control program used in a programmable logic controller or a graphic logic controller which includes a communication section for enabling connection to a network, wherein
the control program creation device includes a command creation section for creating, as a command in the control program, a terminal control command for controlling a terminal connected to the network.
